(19) United States
(12) Patent Application Publication
(10) Pub. No.: US 2010/0215198 A1
(43) Pub. Date: Aug. 26, 2010

(54) HEADSET ASSEMBLY WITH AMBIENT SOUND CONTROL

(76) Inventors: Lester S. H. Ngia, Troy, MI (US); Dong Lin, Fremont, CA (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/703,363

(22) Filed: Feb. 10, 2010

Related U.S. Application Data
(60) Provisional application No. 61/154,530, filed on Feb. 23, 2009.

(51) Int. Cl. H04R 5/02; G10K 11/16

(52) U.S. Cl. 381/309; 381/71.1; 381/71.7; 381/74

(57) ABSTRACT

An ambient sound control headset includes an external microphone and an earpiece with an internal speaker. A circuit acts upon a signal output by the external microphone to form a signal representative of a user's environment that is input to the internal speaker. Components of the signal output by the external microphone that have a corresponding volume level that are less than a predetermined threshold are allowed to pass to the internal speaker and components of the signal output by the external microphone that have a corresponding volume level that are greater than the predetermined threshold are compressed to have a volume that is less than the predetermined threshold.

### RELATED APPLICATION DATA

This application claims the benefit of U.S. Provisional Patent Application No. 61/154,530 filed Feb. 23, 2009, the disclosure of which is incorporated herein by reference in its entirety.

### TECHNICAL FIELD

The technology of the present disclosure relates generally to headset assemblies and, more particularly, to a headset assembly that includes ambient sound control.

### BACKGROUND

In certain situations, a person may wish to communicate with others, but ambient sound may be too loud to hear the other person. For instance, in a combat environment, a soldier may wish to communicate with other soldiers over a radio system, but gunshots, explosions, vehicles and other sound sources may be too loud to hear other persons over the radio system. Also, the amplitude of the ambient sounds may be loud enough that hearing damage is possible. Another exemplary situation is at a construction site where workers may be using hammers, power tools and the like so as to result in an amount of noise that makes speaking to a commonly located coworker difficult.

### SUMMARY OF THE INVENTION

To reduce the volume of loud noises at an ear of a user, the present disclosure describes an improved headset having ambient sound control. The sound control may afford a user hearing protection from loud noises. Also, the sound control may be configured to allow quieter sounds to be heard at approximately their native volume. In this manner, a user may be able to communicate with others while not being influenced by loud sounds (e.g., sounds over a predetermined threshold, such as sounds over about 70 dBA or sounds over about 90 dBA). In one embodiment, the loud sounds are compressed so as to have an effective volume to the user that is less than the predetermined threshold. In this manner, the user may still be able to hear the loud sound, but not at its full volume.

According to one aspect of the disclosure, an ambient sound control headset includes an external microphone that detects sounds from an environment of a user and outputs a corresponding signal; an earpiece configured for at least partial insertion into an ear of a user and having an internal speaker driven by an input signal to emit sounds to an ear canal of the user, the emitted sounds representing the sounds from the environment; and a circuit that is configured to amplify and act upon the signal output by the external microphone to form the signal input to the internal speaker in which components of the amplified signal output by the external microphone that have a corresponding volume level that are less than a predetermined threshold are allowed to pass to the internal speaker and components of the amplified signal output by the external microphone that have a corresponding volume level that are greater than the predetermined threshold are compressed to have a volume that is less than the predetermined threshold.

According to one embodiment of the headset, the external microphone is retained by the earpiece.

According to one embodiment of the headset, the circuit includes an amplifier that amplifies the signal output by the microphone.

According to one embodiment of the headset, the amplifier includes a preamplifier and a power amplifier.

According to one embodiment of the headset, the circuit has a resistor in series with the internal speaker and a pair of diodes in parallel with the series resistor and speaker, the diodes arranged in parallel and having opposing bias directionalities.

According to one embodiment of the headset, when a forward bias voltage of one of the diodes is exceeded by the amplified signal output by the external microphone, the diode conducts to clamp a voltage across the speaker.

According to one embodiment of the headset, a bias voltage is applied to the diode pair to reduce a forward bias voltage threshold of at least one of the diodes.

According to one embodiment of the headset, a first capacitor is arranged in series with the resistor and internal speaker, and a second capacitor is arranged in series with the amplifier, the first and second capacitors configured to respectively block DC current to the internal speaker and the amplifier.

According to one embodiment of the headset, the electrical circuit is configured to filter high frequency components of the signal input to the internal speaker.

According to one embodiment of the headset, a capacitor is arranged in parallel with the internal speaker to filter the high frequency components.

According to one embodiment of the headset, the resistor is a variable resistor.

According to one embodiment, the headset further includes a second external microphone that detects sounds from the environment of a user and outputs a corresponding signal; a second earpiece configured for at least partial insertion into a second ear of a user and having a second internal speaker driven by an input signal to emit sounds to a second ear canal of the user, the emitted sounds representing the sounds from the environment; and wherein the circuit is configured to amplify and act upon the signal output by the second external microphone to form the signal input to the second internal speaker in which components of the amplified signal output by the second external microphone that have a corresponding volume level that are less than the predetermined threshold are allowed to pass to the second internal speaker and components of the amplified signal output by the second external microphone that have a corresponding volume level that are greater than the predetermined threshold are compressed to have a volume that is less than the predetermined threshold.

According to one embodiment of the headset, the second external microphone is retained by the second earpiece.

According to one embodiment of the headset, the microphones and speakers cooperate to provide stereophonic listening of the environment to the user.

According to one embodiment of the headset, the external microphones are retained by respective earmuffs, each surrounding a corresponding outer ear portion of the user and a corresponding earpiece.

According to one embodiment of the headset, the earpiece includes an internal microphone to detect sounds from the ear canal of the user and output a signal corresponding to the detected sounds.

According to one embodiment of the headset, the external microphone is retained by an earmuff that surrounds an outer ear of the user and the earpiece.

According to one embodiment of the headset, the earpiece has an electrical connector to connect to a mating electrical connector of the earmuff to establish electrical interface of components of the earpiece with components retained by the earmuff.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a representation of an exemplary headset assembly having ambient sound control;

FIG. 2 is a schematic diagram of an exemplary ambient sound control circuit;

FIG. 3 is a schematic diagram of an exemplary electrical circuit that includes the ambient sound control circuit and interfaces the headset with an electronic device;

FIGS. 4A to 4C are graphs of ambient sound control circuit performance for different input signal levels;

FIG. 5 is a representation of an exemplary test platform for the ambient sound control circuit;

FIGS. 6 and 7 are graphs of speaker output for experiments conducted using the test platform of FIG. 5;

FIGS. 8A, 8B and 8C are schematic diagrams of additional exemplary ambient sound control circuits;

FIG. 9 is a schematic diagram of still another exemplary ambient sound control circuit;

FIGS. 10 and 11 are graphs of the frequency response of speaker output for the ambient sound control circuit of FIG. 9;

FIG. 12 is a graph of speaker output for experiments conducted using modified versions of the test platform of FIG. 5; and

FIG. 13 is a representation of another exemplary headset assembly having ambient sound control.

### DESCRIPTION

### I. Introduction

In the description that follows, like components have been given the same reference numerals, regardless of whether they are shown in different embodiments. To illustrate an embodiment(s) of the present invention in a clear and concise manner, the drawings may not necessarily be to scale and certain features may be shown in somewhat schematic form. Features that are described and/or illustrated with respect to one embodiment may be used in the same way or in a similar way in one or more other embodiments and/or in combination with or instead of the features of the other embodiments.

### II. Headset Assembly

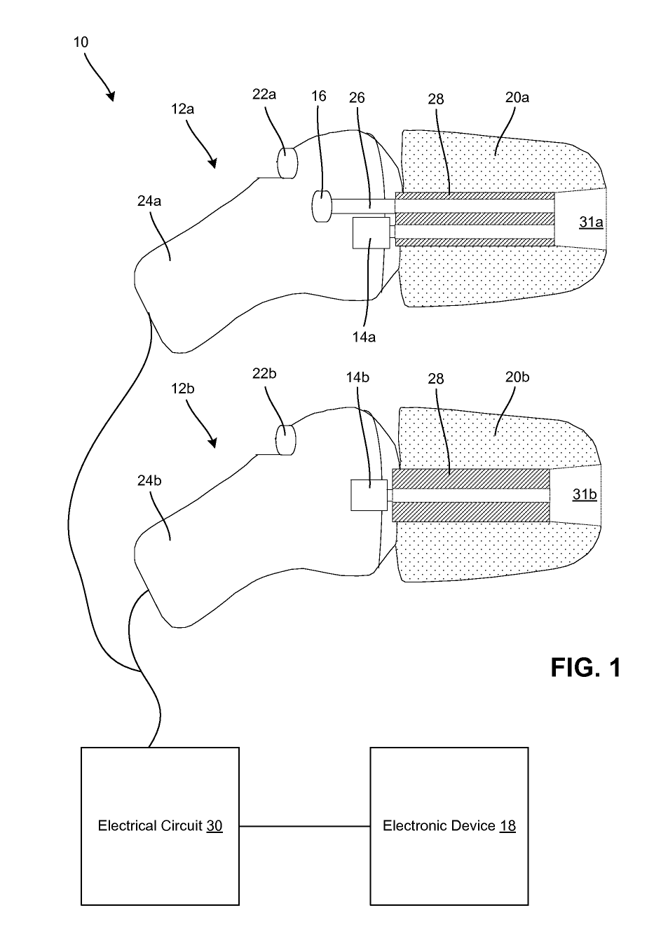

With reference to FIG. 1, illustrated is an exemplary headset assembly 10 that depicts an exemplary operational context in which an ambient sound control circuit may operate. The headset assembly 10 includes a first earpiece 12a and a second earpiece 12b, respectively for use with the ears of a user. The earpieces 12 may be constructed in the manners described in U.S. patent application Ser. Nos. 12/272,131 and 12/272,142, the disclosures of which are incorporated herein by references in their entireties. For the sake of brevity and to avoid repetition of the earpiece descriptions relative to these patent documents, the construction and general operation of the earpieces 12 will not be described.

Briefly, each earpiece 12 may include an internal speaker 14a, 14b, to emit sound into respective ear canals of the user. The first earpiece 12a also includes an internal microphone 16, although it is possible that both earpieces 12 may have an internal microphone 16. The internal microphone 16 is positioned with respect to one of the user's ear canals to detect acoustic signals from the user's ear, including, for example, speech, grunts, whistles, singing, coughs, clicking sounds made by movement of the lips or tongue, and the like. The illustrated exemplary headset assembly 10 allows the user to use the headset 10 in conjunction with both audio playback as well as voice communication in a hands free manner. The apparatus may be used in conjunction with an electronic device 18. Exemplary electronic devices 18 include a communication device (e.g. a mobile phone), a voice recognition device, a speech recognition device, a control assembly for a machine (e.g., a robot or a wheel chair), and so forth.

Each earpiece 12 is retained by one of the ears of the user by inserting a tip 20 of the earpiece 12 at least partially into the ear of the user. In one embodiment, sounds are conveyed from an ear canal of the user to the internal microphone 16 through an air medium via an acoustic waveguide with characteristics specially designed to achieve a desired sound quality. An input portion of the microphone 16 may be in fluid communication with the ear canal. Hence, the headset assembly does not rely on the detection of sound that has emanated directly from the user's mouth. Sounds are also conveyed from the internal speaker(s) 14 of the earpieces 12 to the ear canals of the user. In one embodiment, sounds from the speakers 14 are conveyed through an air medium via an acoustic waveguide with characteristics specially designed to achieve a desired sound quality.

Also, the earpieces 12 each include an external microphone 22 located on a housing 24 the respective earpieces 12. The external microphones 22 allow the user to hear ambient sounds while the user is using the headset assembly. For purposes of the description, ambient sounds (also referred to as ambient noise) includes those sounds generated external to the ear, such as sounds from the user's environment, a person talking to the user, etc.

The microphone 16 and/or the speakers 14 may be acoustically coupled to the respective ear canals with an acoustic pathway that behaves, at least in part, as an acoustic waveguide. The length, cross-sectional area and material used to make the acoustic waveguide may be selected to affect the spectrum of the captured microphone signal and emitted speaker signals, such as amplifying desired frequencies and/or attenuating other, less desirable, frequencies. The acoustic pathway that behaves as an acoustic waveguide may be made, at least in part, from a tube 26, a stem 28, the earpiece tip 20, or a combination of these components.

If the headset 10 is used with an electronic device 18, the microphones 16, 22 and the speakers 14 may interface with the electronic device 18 through an electrical circuit 30. The electrical circuit 30 will be described in greater detail below. The electrical circuit 30 may have a wired or wireless connection with the electronic device 18. In the case of a wireless connection, the electrical circuit 30 may include a wireless transceiver, such as a Bluetooth® transceiver.

The earpiece 12 may be used by inserting the tip 20 at least partially into the ear of a person, such as by placing the tip 20 near the opening of the ear canal or slightly into the ear canal. An opening 31 in the tip 20 preferably should be in fluid communication with the ear canal of the user.

The earpiece housing 24 may be constructed from any suitable material, such as plastic, rubber, or the like. The earpiece housing 24 may define a hollow cavity in which the operative components (e.g., microphone 16 and/or speaker 14) are placed. The earpiece housing 24 may take on a number of different physical configurations. For example, the earpiece housing 24 may resemble a miniature earphone as found in conventional telephone headsets or as used with personal audio/music players (e.g., an earbud). Alternatively, the earpiece housing 24 may resemble the housing design of a hearing aid, particularly a digital hearing aid.

The earpiece tip 20 may be constructed from any suitable material, such as foam, plastic, gel, rubber, or the like. Examples of suitable, commercially available earpiece tips are Comply Canal Tips, available from Hearing Components of Oakdale, Minn. The earpiece tip 20 is at least partially inserted into the ear of the user, such as by placing the end of the earpiece tip 20 distal to the earpiece housing 24 near the opening of the ear canal or slightly into the ear canal. Some compression of the earpiece tip 20 may occur upon insertion and the tip 20 may conform to the anatomy of the user's ear to fluidly seal the ear canal of the user from the surrounding environment.

The tip 20, the stem 28 and the tube 26 each include at lest one channel or passageway that allows acoustic signals to pass from the ear canal of the user to an internal microphone 16 and/or the speakers 14.

The internal microphone 16 is used to detect sounds, in, near, and/or emanating from the ear canal of the user. The internal microphone 16 converts those detections into an electrical signal that is input to the electronic device 18. Examples of suitable, commercially available, microphones include OWMO-4015 Series microphones manufactured by Ole Wolff Manufacturing, Inc. of Chicago, Ill., and MAA-03A-L Series manufactured by Star Micronics America, Inc. of Edison, N.J. Examples of suitable speakers include model number BK26824 or model number ED3162 available from Knowles of Itasca, Ill.

### III. Control Circuitry

### III(a). Electronic Device Interface

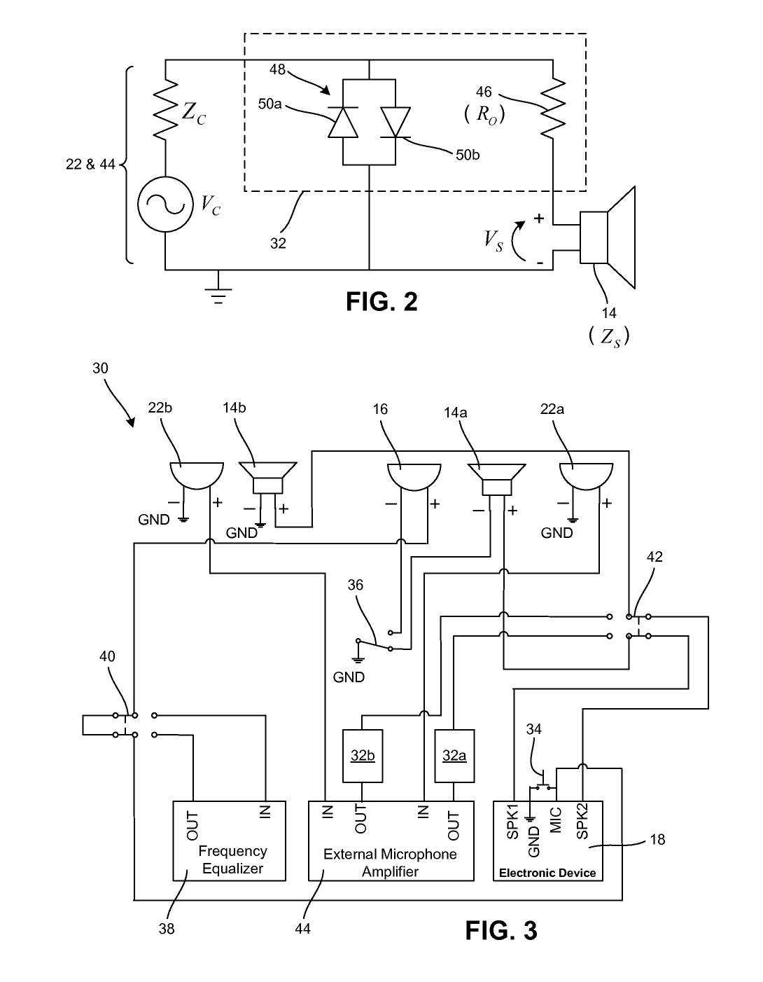

In one embodiment, the electrical circuit 30 includes an ambient sound control circuit. With additional reference to FIG. 2, an exemplary ambient sound control circuit 32 is shown. In the illustrated embodiment, a voltage source V_{c} models an amplified output of one of the external microphones 22 and impedance Zₛ models the behavior of the corresponding speaker 14. The impedance of the voltage source (e.g., internal impedance of an amplifier assembly used to amplify the output of the microphone 22) is represented by source impedance Z_{c}. Therefore, the equivalent circuit of voltage source V_{c} and source impedance Z_{c} may be thought of as representing the external microphone 22 and an amplifier assembly (described below) that amplifies the output of the external microphone 22. Also, impedance Zₛ may be thought of as representing the corresponding speaker 14.

In operation, the external microphone 22 may detect sounds from the user's environment and convert those sounds to an electrical signal, which is amplified. The amplified signal is coupled to the speaker 14 with the components of the ambient sound control circuit 32. Operation and features of the ambient sound control circuit 32 will be described below. The signal output by the ambient sound control circuit 32, which is represented by speaker voltage Vₛ in FIG. 2 is applied to the terminals of the speaker 14, which converts the electrical signal into a sound signal that may be heard by the user. In this manner, sounds from the user's environment are detected and played back to the user.

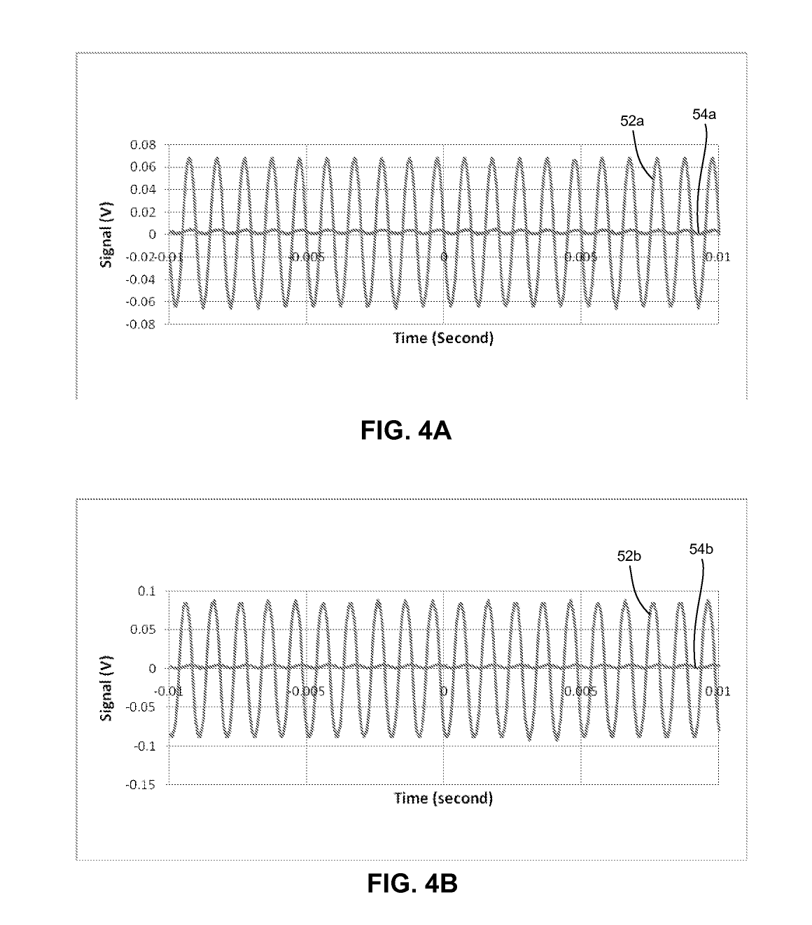

With additional reference to FIG. 3, the ambient sound control circuit 32 is shown as part of the electrical circuit 30 that, in the illustrated embodiment, contains components to allow switching between an audio listening state and a communication state. For example, the headset assembly 10 may be used with the illustrated electrical circuit 30 to allow the user to listen to audio playback and/or listen to the user's surrounding environment, as well as engage in bidirectional communication. In one embodiment, frequency equalization is applied to the output signal from the internal microphone 16. In another embodiment, the electrical circuit 30 allows switching between listening to output from the electronic device 18 and ambient sound detected by one or both of the external microphones 22. The switching may be performed by manual use of switches, command inputs or menu selections made by the user, by automatic action as determined by control logic, or a combination of these techniques.

It will be appreciated that the ambient sound control circuit 32 may be used in other arrangements. For instance, the headset 10 may be configured simply as a hearing protection device where the electrical circuit 30 is of less elaborate design, but in which the ambient sound control circuit 32 couples the amplified microphone signal to the speaker 14.

In the audio listening state of the illustrated exemplary electrical circuit 30, the electrical circuit 30 is configured to operatively couple the internal speakers 14 to the electronic device 18 for listening to stereo audio playback of audio content, and the internal microphone 16 is switched to an off state. The playback may be of recorded audio content that is stored by the electronic device 18 or may be audio content that is received by the electronic device 18, such as with a radio or data receiver. In the communication state, the electrical circuit 30 is configured to switch the internal microphone 16 to an on state for voice communication, and switch the internal speaker 14a to an off state while maintaining the operative coupling of the internal speaker 14b to the electronic device 18. In this manner, the user may use the electronic device 18 to engage in voice communications. Speech from the user may be detected with the microphone 16 and input to the electronic device 18 for transmission. Received sounds (e.g., from a remote person involved in the voice conversation) may be output from the electronic device 18 to the speaker 14b.

The external microphones 22 are used to detect ambient sound, such as sounds from the surrounding environment or the voice of a co-located person with whom the user is speaking. The detected sound may be output to the user with at least one of the internal speakers 14. In one embodiment, the electrical circuit 30 enables the user to switch between listening to ambient sound detected by the microphone(s) 22 and the playback of audio.

FIG. 3 illustrates an exemplary schematic of the electrical circuit 30. The electrical circuit 30 couples the internal microphone 16 and internal speakers 14 of the first and second earpieces to the electronic device 18. The electronic device 18 may have a first speaker output port (SPK1), a second speaker output port (SPK2), a microphone input port (MIC), and a ground port (GND). The internal microphone 16 of the first earpiece is coupled to the MIC port of the electronic device 18, the internal speaker 14a of the first earpiece is coupled to the SPK1 output port of the electronic device, and the internal speaker 14b of the second earpiece is coupled to the SPK2 output port of the electronic device.

The electrical circuit 30 includes a hook condition switch 34 that selectively couples the MIC port and GND port, and provides an on-hook or off-hook condition of the electronic device 18, similar to a conventional telephone. In one embodiment, the hook condition switch 34 is a push-button switch. However, the hook condition switch 34 may be any suitable switch. In another embodiment, for example, the on-hook/off-hook condition is instead controlled by executable logic or a programmed controller. When the hook condition switch 34 is in an open state, the switch provides an on-hook condition. When the hook condition switch 34 is in a closed state, a resistance short is created between the internal microphone port (MIC port) and the ground port (GND port) of the electronic device 18 to establish an off-hook condition.

The electrical circuit 30 further includes an audio state switch 36 that selectively couples either the internal speaker 14a or the internal microphone 16 of the first earpiece to ground. In one embodiment, the audio state switch 36 is a single-pole double-throw switch. However, the audio state switch 36 may be any suitable switch. In another embodiment, for example, the audio state is instead controlled by executable logic or a programmed controller. When the headset 10 is in the audio listening state, the audio state switch 36 effectively completes a circuit connection of the internal speaker 14a with the electronic device 18, thereby activating the internal speaker 14a and deactivating the internal microphone 16. When the headset is in the communication state, the audio state switch 36 effectively completes the circuit connection of the internal microphone 16 with the electronic device 18, thereby activating the internal microphone 16 and deactivating the internal speaker 14a. This switching allows the user to engage in bidirectional communication while minimizing echoing or feedback caused by having both the internal microphone 16 and internal speaker 14a of the first earpiece 12a activated at the same time.

It will be understood that both the hook condition switch 34 and the audio state switch 36 can be controlled independently of one another, or may be controlled in a coordinated manner.

A frequency equalizer 38 may be incorporated into the electrical circuit 30. In one embodiment, the internal microphone 16 and the MIC port of the electronic device may be coupled through the frequency equalizer 38. The frequency equalizer 38 may provide frequency equalization for the purpose of shaping a desired frequency envelope on the captured signal from the internal microphone 16. The frequency equalizer 38 may compensate for differences in detected speech from the ear canal of the user relative to if the speech had been detected from the mouth of the user. In the illustrated embodiment, the frequency equalizer 38 may be bypassed with a frequency equalization switch 40. In one embodiment, the frequency equalization switch 40 is a double-pole double-throw switch. However, the frequency equalization switch 40 may be any suitable switch. In another embodiment, for example, frequency equalization is controlled by executable logic or a programmed controller. The frequency equalization switch 40 switches between a bypass mode, in which the internal microphone 16 is coupled to the electronic device 18 without the frequency equalizer 38, and a frequency equalization mode, in which the internal microphone 16 is coupled to the electronic device 18 through the frequency equalizer 38.

An external sound control switch 42 may be used to selectively couple either the external microphones 22 or the SPK1 and SPK2 ports of the electronic device 18 to the internal speakers 14. The external sound control switch 42 may provide the user the option of switching between an output from the electronic device 18 during audio playback (or during bidirectional communication) and an output from the external microphones 22. For example, if a user is listening to audio playback or is engaged in bidirectional voice communication, the user may switch the external sound control switch 42, thereby allowing the user to listen to ambient sound instead of the audio playback or conversation involving the electronic device 18. In one embodiment, the external sound control switch 42 is a double-pole double-throw switch. However, the external sound control switch 42 may be any suitable switch. In another embodiment, for example, the external sound control is controlled by executable logic or a programmed controller. In the illustrated embodiment, when the external microphones 22 are used during bidirectional communication, the signal representation of ambient sound is only output by the internal speaker 14b of the second earpiece.

An audio mixer (not shown) may be added so that signals from the external microphones 22 may be combined with signals from the electronic device 18 during either or both of audio playback or voice communications.

As indicated, the representation of ambient sound detected by the external microphone(s) 22 may be passed through an external microphone amplifier 44 that is used to control (e.g., amplify or attenuate) the amplitude of the signal captured by the external microphone(s) 22 before being output by the internal speakers 14. In one embodiment, the amplifier 44 may include a preamplifier and a power amplifier for each channel (e.g., a signal pathway for each external microphone 22).

In an embodiment where both the first and second earpieces include external microphones 22, the audio signal representation of ambient sound of the external microphone 22a retained by the first earpiece 12a may be output to the user with the internal speaker 14a of the first earpiece 12a, and the audio signal representation of ambient sound of the external microphone 22b retained by the second earpiece 12b may be output to the user with the internal speaker 14b of the second earpiece 12b. This arrangement may mimic the natural stereophonic hearing of ambient sounds. In another embodiment, only one of the first or second earpieces may include an external microphone 22, and the audio signal representation of ambient sound of the external microphone 22 may be output to the user with either or both of the internal speaker(s) 14 of the first and second earpieces 12.

In addition, a first ambient sound control circuit 32a may be included between the speaker 14a and the output port of the amplifier 44 corresponding to the external microphone 22a. Similarly, a second ambient sound control circuit 32b may be included between the speaker 14b and the output port of the amplifier 44 corresponding to the external microphone 22b. In the illustrated embodiment, the circuits 32 are positioned between the amplifier 44 and the switch 42. In another embodiment, the circuits 32 may be positioned between the switch 42 and the speakers 14. Operation of the ambient sound control circuits 32 to regulate the output of relatively loud sounds will be described below.

### III(b). Ambient Sound Control

The ambient sound control circuit 32 may be configured to assist in reducing the volume of relatively loud sounds to which the user is exposed. Exemplary sources of loud sounds may include, but are not limited to, guns, canons, power tools, engines, amplified music, and so forth.

The above-described earpieces 12 may provide relatively good sound attenuation to the user due to the conformance of the tip 20 with the anatomy of the ear. Laboratory measurement has shown that the attenuation can be about 20 dB to about 30 dB in noise reduction rating (NRR). Since this amount of sound attenuation can result in the user's inability to hear relatively low volume ambient sounds, the external microphones 22 may be used to capture the ambient sound. As described, the captured sound may be played back by the internal speakers 14 so that the user may hear sounds from his or her surroundings. The volume of playback may be controlled with the amplifier 44. Usually, the amplifier 44 is set so that sounds are output to the user by the speakers 14 at a comfortable level, such as about 60 dBA to about 70 dBA. But if there is a sudden “burst” of loud ambient sound surrounding the user, the user may be incapable of reducing the volume at the power amplifier in time before the sound is played back at an uncomfortable, or even damaging, level. Repeated exposure to sounds that are above about 90 dBA may cause a hearing loss, for example.

The disclosed ambient sound control techniques may reduce, or even eliminate, exposure of the user to sounds above levels that could lead to hearing loss where relatively loud ambient noise is captured by external microphones 22 and played through the internal speakers 14 of the headset 10.

The general technique employed by the ambient sound control circuit 32 is to allow sound signals with a corresponding volume level that is less than a predetermined threshold to pass through to the speaker 14 for playback. But sound signals with a corresponding volume level that is higher than the predetermined threshold are compressed into a lower volume range before being played at the speaker 14. The predetermined threshold is determined by circuit components as will be described in greater detail below. In some embodiments, the predetermined threshold may be variable when one or more variable circuit components are used. In this manner, the disclosed headset 10 may be used to provide the user “situational awareness” that includes full hearing function for sounds with volumes below a predetermined threshold and hearing protection for sounds with volumes above a predetermined threshold, but where the sounds above the predetermined threshold are played to the user so that the user is aware of the sounds.

The disclosed ambient sound control techniques use a nonlinear circuit to control sound in this manner. With continued reference to FIGS. 1-3, the output of one of the channels of the amplifier 44 may be connected to the nonlinear ambient sound control circuit 32, the output of which is coupled to a corresponding speaker 14.

The illustrated embodiments of the disclosed techniques are implemented using hardware components (e.g., discrete electrical components). It is emphasized that the disclosed techniques instead may be implemented by executable logic that is stored in a computer readable medium and executed by a general purpose processor, may be implemented by programmed controller, or some combination of hardware and programmed implementation. Therefore, the term circuit expressly includes any arrangement of discrete electrical components and/or processing components (e.g., general purpose processor, dedicated purpose processor, and/or associated memory).

As indicated, in FIG. 2, the microphone 22 and amplifier 44 are modeled in FIG. 2 by the equivalent circuit of voltage source V_{c} and source impedance Z_{c}, and the speaker is modeled by impedance Zₛ. The ambient sound control circuit 32 includes a resistor 46 (also referred to as Rₒ) and a diode pair 48. The resistor 46 may have a fixed resistance or may have variable resistance (e.g., if implemented with a potentiometer) and is placed in series with the speaker 14. The diode pair 48 has a first diode 50a and a second diode 50b that are arranged in parallel, but with opposing directionalities. The diode pair 48 is placed in parallel with the resistor 46 and speaker 14.

As will be understood, a diode allows electric current to pass in one direction (referred to as a forward biased condition) and blocks current in the opposite direction (referred to as a reverse biased condition). Therefore, the diodes 50 of the diode pair 48 have opposite biased conditions. The ambient sound control primarily makes use of the forward biased condition of the diodes 50. For purposes of this description, Vₒₙ may be considered a forward voltage threshold that “turns on” the diode pair 48. Typically, when the forward voltage of a diode is less than Vₒₙ, the diode 50 will not conduct; and when the forward voltage of the diode is higher than Vₒₙ, the diode 50 will conduct. Therefore, when the forward voltage is less than Vₒₙ, the diode 50 behaves like an open circuit that has a very high resistance; and when the forward voltage is higher than Vₒₙ, the diode 50 behaves like a closed, or short, circuit that has a very small resistance.

When the forward voltage across one of the diodes 50 of the diode pair 48 is higher than Vₒₙ, that diode 50 will behave as a closed circuit and hold its voltage at about Vₒₙ. Therefore, the voltage across resistor 46 and the speaker 14 (e.g., as represented by impedance Zₛ) will be clamped to about Vₒₙ. Letting Vₛ be the voltage driving the internal speaker, equation 1 indicates that V_{sc} is the voltage driving the speaker 14 when the diode pair 48 behaves as a closed circuit.

$${V}_{SC} \approx {V}_{ON} \frac{{Z}_{S}}{{R}_{O} + {Z}_{S}} \qquad Eq . 1$$

When the forward voltage across one of the diodes 50 from the diode pair 48 is lower than Vₒₙ, that diode 50 will behave as an open circuit. In that case, equation 2 indicates that Vₛₒ is the voltage driving the speaker 14 when the diode pair 48 behaves as an open circuit.

$${V}_{SO} = {V}_{C} \frac{{Z}_{S}}{{Z}_{C} + {R}_{O} + {Z}_{S}} \qquad Eq . 2$$

In a relatively noisy environment (e.g., an environment with noises above the predetermined threshold), such as in the presence of a gunshot or a canon firing, V_{c} may be quite large and may cause the forward voltage across one of the diodes 50 of the diode pair 48 to be higher than Vₒₙ. Under this condition, Vₛ will become V_{sc} as in equation 1. The values for Vₒₙ, Zₛ, and Rₒ may be selected such that the driving voltage to the speaker 14 is effectively attenuated so that the loud sound may be heard, but at a comfortable level by the user.

In a relatively quiet environment (e.g., an environment with noises below the predetermined threshold), V_{c} is usually relatively small and may cause the forward voltage across one of the diodes 50 from the diode pair 48 to be smaller than Vₒₙ. Under this condition, Vₛ will become Vₛₒ as in equation 2. Using predetermined values for Zₛ, Z_{c}, and Rₒ, the voltage to the speaker 14 can be controlled such that the user may hear sounds from the speaker 14 at a desired level. For example, speech from another person that is captured by the external microphones 22 may be heard comfortably by the user. It is noted that the source impedance Z_{c} may be harder to adjust than Zₛ and Rₒ since Z_{c} is the equivalent impedance for the combination of the microphone 22 and the amplifier 44. But, the value for V_{c} may be controlled by adjusting the amplifier 44, thereby changing the performance of the circuit 32 based on the input voltage. Therefore, the effect of Z_{c} on the performance of the circuit 32 may be ignored by controlling the value for V_{c}. Also, if the resistor 46 is variable, then the user may adjust the performance of the circuit 32 by effectively adjusting the values of Vₛₒ and V_{sc}, thereby controlling the loudness of the speaker 14.

Equations 1 and 2 show that the circuit diagram in FIG. 2 may provide the desired nonlinearity for controlling the loudness of sound to be played by the speakers 14 during “normal” and “high level” ambient noise. An exemplary suitable diode for use in the diode pair 48 is model number DFLS120L available from DIODES Incorporated of Westlake Village, Calif. Another exemplary diode is model number STPS40L15CWPBF available from Vishay Intertechnology, Inc. of Malvern, Pa.

### III(c). Experiments

Experiments were conducted to verify the operation of the disclosed ambient sound control techniques.

### III(c)(i). Sinusoid Voltage Source

In a first experiment, the voltage across the diode pair 48 and the voltage across the speaker (or Vₛ) are measured for different amplitude levels of a sinusoidal voltage source (or V_{c}). The experiment uses the nonlinear circuit arrangement as shown in FIG. 2. The voltage source V_{c} is a 1 kHz sine wave generated by a signal generator. The source impedance Z_{c} is about 50 ohms (Ω), and can be ignored for purposes of obtaining experimental results. The resistor 46 during the experiment is a 1 kΩ resistor. The diodes 50 are model number DFLS120L as described above and the speaker is model number BK26824 as described above.

Table 1 shows the peak-to-peak voltage (Vₚₚ) of the 1 kHz sine wave generated by the signal generator, and the corresponding measured Vₚₚ across the diode pair 48. The results show the voltage across the diode pair 48 does not increase linearly with respect to the amplitude of the voltage source V_{c}. For example, when Vₚₚ of V_{c} is at 0.4 V, Vₚₚ across the diode pair 48 is 0.212 V; and when Vₚₚ of V_{c} is at 5.0 V, Vₚₚ across the diode pair 48 is 0.408 V.

TABLE 1

| Vₚₚ of V_{c} (Volts) | 0.2 | 0.3 | 0.4 | 0.5 | 1.0 | 2.0 | 5.0 | 10.0 | 20.0 |
|---|---|---|---|---|---|---|---|---|---|
| Vₚₚ across | 0.142 | 0.184 | 0.212 | 0.232 | 0.286 | 0.344 | 0.408 | 0.472 | 0.556 |
| diode pair | | | | | | | | | |
| (Volts) | | | | | | | | | |

The results show that when the amplitude of the voltage across the diode pair 48 (i.e., half of Vₚₚ) is more than the forward voltage threshold Vₒₙ (i.e., about 0.2 V for the diode model used), one of the diodes 50 of the diode pair 48 will behave like a closed, or short, circuit and the voltage across the diode will be clamped. The voltage across the diode pair 48 will be held to about Vₒₙ, even when the amplitude of V_{c} is increased. Therefore, the overall results shown that the voltage across the diode pair 48 will be clamped to about Vₒₙ when the forward voltage of either of the diodes 50 is more than Vₒₙ.

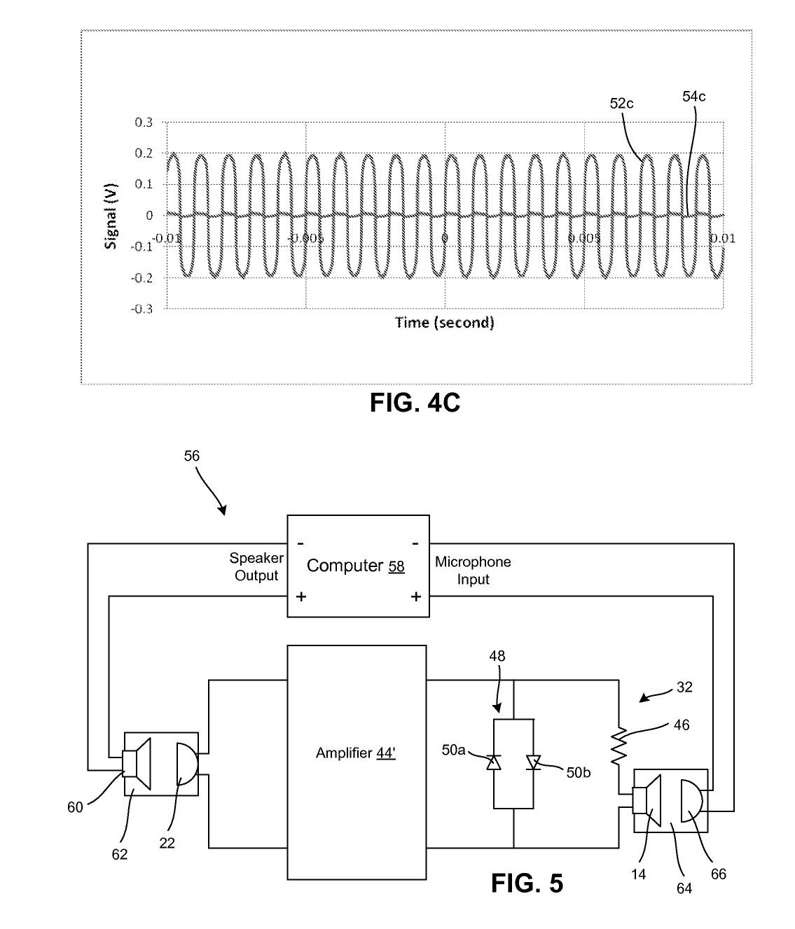

FIGS. 4A through 4C show the measured signals across the diode pair 48 and the speaker 14 for three Vₚₚ levels of the voltage source V_{c}. FIG. 4A shows the response for Vₚₚ voltage source V_{c} output of 200 mV. FIG. 4B shows the response for Vₚₚ voltage source V_{c} output of 300 mV. FIG. 4C shows the response for Vₚₚ voltage source V_{c} output of 5,000 mV. In the FIGS. 4A through 4C, curves 52a, 52b, and 52c respectively show the voltage across the diode pair 48 and curves 54a, 54b, and 54c respectively show the voltage across the speaker 14.

The results are similar to those shown in Table 1. That is, the voltages across the diode pair 48 and speaker 14 do not increase linearly with the amplitude of the voltage source V_{c}. The results also show that when one of the diodes 50 “turns on” causing the signals across the diode pair 48 and speaker 14 to be held to certain voltages, distortions to the signals may be introduced. The distortion is more pronounced when the voltage source V_{c} drives with a higher level of Vₚₚ, such as 5 V, as observed in FIG. 4C. However, most of these distortions are subtle enough so that they may not be audible to a human ear.

### III(c)(ii). Acoustic Voltage Source

In a second experiment, the acoustic output of the speaker 14 is measured in an arrangement where an amplified signal that is generated by the external microphone 22 is the voltage source.

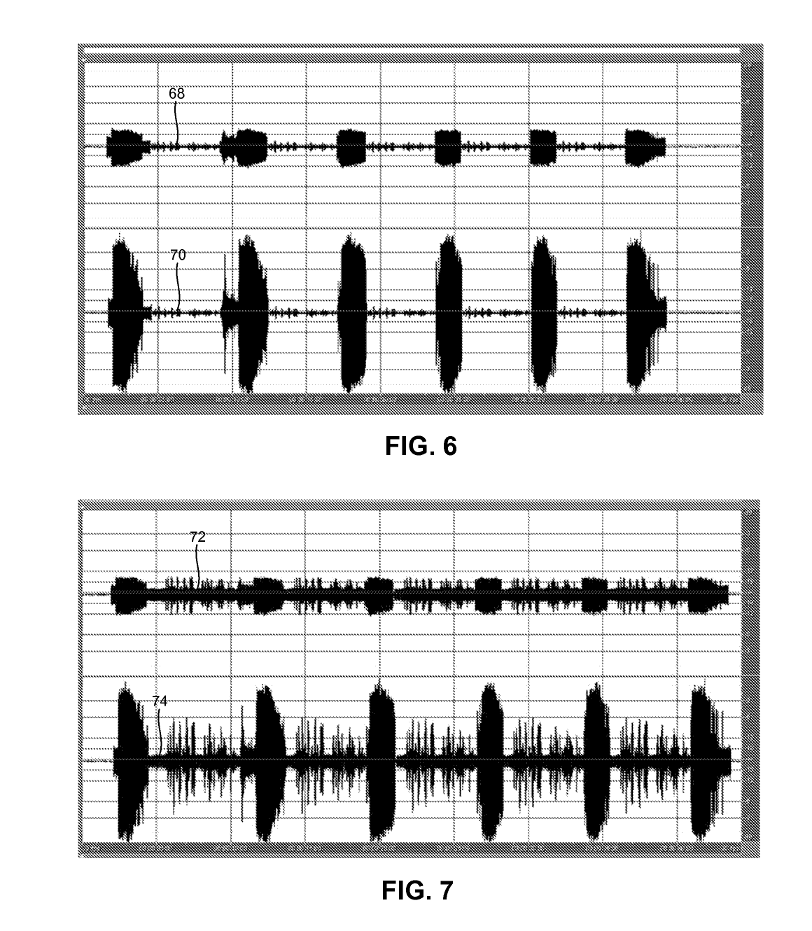

With additional reference to FIG. 5, an experimental test platform 56 is shown. A computer 58 is used to drive a test platform speaker 60 so that the speaker 60 outputs sounds that simulate a noisy environment. The speaker 60 was implemented with model number ED3162 as described above. The sound output by the speaker 60 is detected by the external microphone 22 and the output from the microphone is amplified with an amplifier 44′. The speaker 60 and the microphone 22 are enclosed in a tube 62 so that sound is directly communicated from the speaker 60 to the microphone 22. The output of the amplifier 44′ is input to the circuit 32 having the diode pair 48 (implemented with model number DFLS120L diodes 50) and the resistor 46 (implemented with a 4.8 kΩ resistor).

The output of the circuit 32 is input to the speaker 14, implemented with model number BK26824. The speaker 14 is enclosed in a tube 64 with a test platform microphone 66 so that sound is directly communicated from the speaker 14 to the microphone 66. The microphone 66 is connected to a microphone input of the computer 58, which is configured to capture and analyze the output of the microphone 66 as a representation of the output of the speaker 14 that the user would hear if the earpiece 12 were worn by a user.

The value for the resistor 46 is selected such that acoustic output of the speaker 14 should be in the range of about 60 dBA to about 70 dBA, which is a comfortable level for human hearing. As indicated, the resistor 46 may be implemented with a potentiometer so that the resistance may be changed to accommodate the characteristics of different model speakers and/or to make adjustments for the specific user. The microphones 22, 66 that were used in this experiment were model number MAA-03A-L microphones available from Star Micronics, Inc. of Edison, N.J.

The computer 58 was used to simultaneously generate an audio signal that drives the speaker 60 and record an audio signal captured by the microphone 66. The acoustic output from the speaker 60 simulates ambient sound and the microphone 22 acts as the external microphone 22 of the earpiece 12, and the speaker 14 acts as the internal speaker 14 of the earpiece 12. The amplifier 44′, which is a power amplifier, includes a potentiometer for gain adjustment to control the level of signal applied to the diode pair 48. The gain is adjusted to be large enough to comfortably hear a normal speech conversation, yet small enough to minimize hearing of distortion during a loud speech conversation.

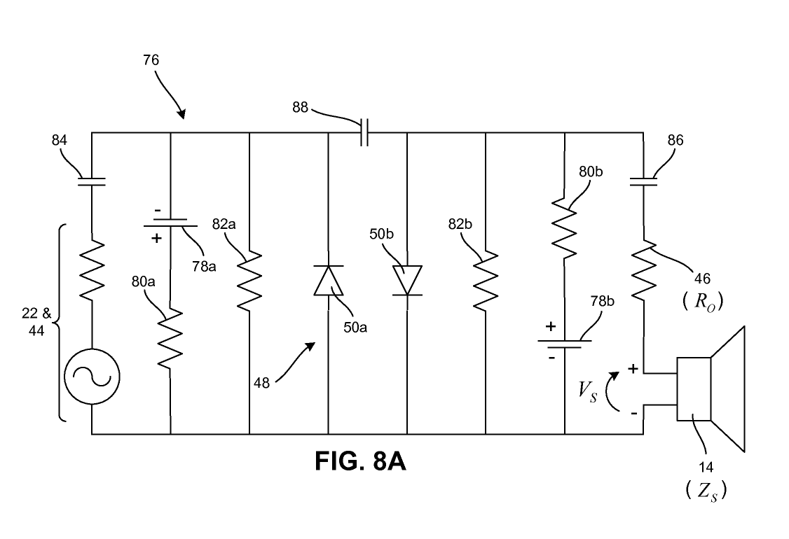

In the experiment, the audio signal that drives the speaker 60 includes representations of speech and impulses representing gunshots. A first audio signal has a gunshot impulse that is 40 dB higher in power spectrum than the speech component. With additional reference to FIG. 6, the top graph 68 shows the output of the speaker 14 when the diode pair 48 is used and the bottom graph 70 shows the output when the diode pair 48 is not used. The results indicate the circuit 32 has compressed and clamped the gunshot impulse to a level that is about 13 dB less than its original level. Also, the speech signal is barely modified by the circuit 32 and would be heard at a comfortable level of about 60 dbA to about 70 dBA. The circuit 32 has not compressed the speech signal because the signal level is below the forward voltage threshold Vₒₙ of the diodes 50.

A second audio signal has gunshot impulses that are 20 dB higher in power spectrum than a speech signal. This was accomplished by increasing the level of speech signal by 20 dB relative to the first signal. With additional reference to FIG. 7, the top graph 72 shows the output of the speaker 14 when the diode pair 48 is used and the bottom graph 74 shows the output when the diode pair 48 is not used. The results indicate the circuit 32 has compressed and clamped the gunshot impulse and has compressed and distorted the speech since some of the amplified speech signal is larger than the forward voltage threshold Vₒₙ of the diodes 50.

### III(c)(iii). Design Consideration from Experimental Results

The experiments show that the volume set in amplifier 44′ controls the signal level that “turns on” the diode pair 48, the threshold Vₒₙ of diode pair 48 limits the voltage level clamped at the speaker 14, and the value for the resistor 46 controls the loudness of sound played by the speaker 14. Therefore, design parameters include the volume level of the amplifier 44′, threshold Vₒₙ of the diodes 50, and value of the resistor 46. Values for these parameters may be selected in coordination with one another to allow for normal volume speech to be heard with minimal distortion and at a comfortable level, and for loud ambient noise to be compressed and held to a level that minimizes the possibility of harmful sound volume. The volume level and the value for resistor 46 may be coordinated with the characteristics of the amplifier 44 and the speaker 14, respectively. Diodes 50 with small forward bias thresholds (Vₒₙ) are preferred, since a relatively small threshold (e.g., in one embodiment, less than 0.4 V, and in one embodiment, less than 0.25 V, and in one embodiment, about 0.2 V) may effectively reduce the maximum voltage applied to the speaker 14.

### III(d). Modified Vₒₙ Threshold

The forward bias voltage threshold Vₒₙ may be effectively modified using a DC bias voltage. A DC voltage may be used to forward bias the diodes 50 to indirectly reduce the threshold at which the diodes 50 “turn on” so that the circuit 32 will start to clamp and compress electrical signals that represent sound capture with the microphone 22.

For example, if a DC voltage of 0.1 V is applied to diode model number DFLS120L, which has a Vₒₙ of 0.2 V, then a voltage from the voltage source V_{c} of 0.1 V would turn on the diode pair 48 instead of the normal 0.2 V.

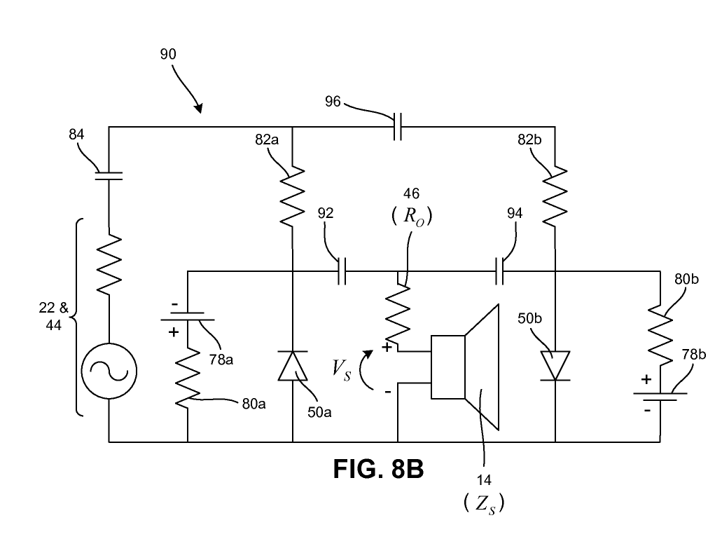

FIGS. 8A, 8B and 8C are schematic diagrams of exemplary ambient sound control circuits that include components to bias the diodes 50. FIG. 8A shows an ambient sound control circuit 76 having a first DC voltage supply 78a to forward bias diode 50a and a second DC voltage supply 78b to forward bias diode 50b. Resistors 80a and 82a function as a voltage divider to divide the voltage supplied by the DC voltage supply 78a so as to control the DC voltage used to bias diode 50a. Similarly, resistors 80b and 82b function as a voltage divider to divide the voltage supplied by the DC voltage supply 78b so as to control the DC voltage used to bias diode 50b. Capacitor 84 is arranged to block DC current from flowing through the amplifier 44 and microphone 16. Capacitor 86 is arranged to block DC current from flowing through the speaker 14. Capacitor 88 is arranged to block voltage supply 78a from reverse biasing diode 50b and to block voltage supply 78b from reverse biasing diode 50a. The remaining components (e.g., the diode pair 48 and the resistor 46) operate in the manners described above.

FIG. 8B shows an ambient sound control circuit 90 having a first DC voltage supply 78a to forward bias diode 50a and a second DC voltage supply 78b to forward bias diode 50b. Resistors 80a and 82a function as a voltage divider to divide the voltage supplied by the DC voltage supply 78a so as to control the DC voltage used to bias diode 50a. Similarly, resistors 80b and 82b function as a voltage divider to divide the voltage supplied by the DC voltage supply 78b so as to control the DC voltage used to bias diode 50b. Capacitor 84 is arranged to block DC current from flowing through the amplifier 44 and microphone 22. Capacitors 92, 94 and 96 are arranged to block DC current from flowing through the speaker 14, to block voltage supply 78a from reverse biasing diode 50b, and to block voltage supply 78b from reverse biasing diode 50a.

FIG. 8C shows an ambient sound control circuit 98 having a first DC voltage supply 78a to forward bias diode 50a and a second DC voltage supply 78b to forward bias diode 50b. Capacitor 84 is arranged to block DC current from flowing through the amplifier 44 and microphone 22. Capacitor 86 is arranged to block DC current from flowing through the speaker 14.

### III(e). High Frequency Attenuation

The foregoing experimental results show that the compressed and clamped gunshot impulses can have rich high frequency components, which may be undesirable to some users. To reduce (e.g., attenuate) the output of high frequency components to the user, the compressed impulse (or any other compressed signal) may be filtered.

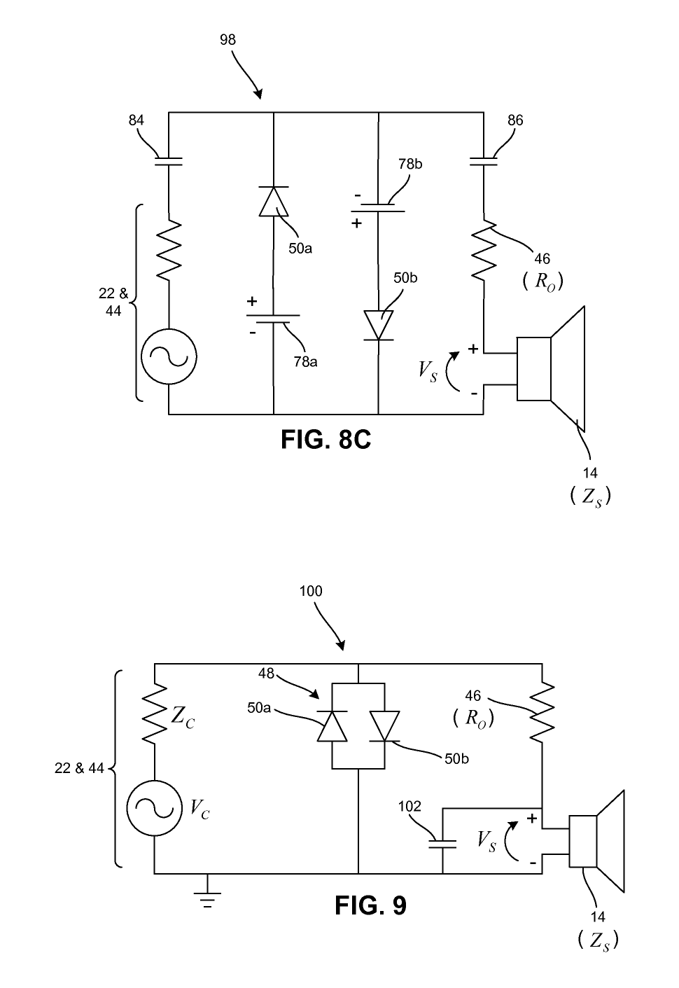

With additional reference to FIG. 9, another embodiment of the ambient sound control circuit 100 is shown. The circuit 100 is the same as the circuit 32 illustrated in FIG. 2, but a capacitor 102 is added in parallel with the speaker 14. In another embodiment, the capacitor 102 may be added to the circuit 76 of FIG. 8A, the circuit 90 of FIG. 8B, or the circuit 98 of FIG. 8C.

Assuming the source impedance Z_{c} is ignored and the impedance Zₛ for speaker 14 is represented by a resistor Rₛ in series with an inductor Lₛ, then the voltage Vₛ across the speaker 14 is given by equation 3, where V_{D} is the voltage across the diode pair 48.

$${V}_{S} = \frac{{R}_{s} + jω {L}_{s}}{{R}_{0} + {R}_{s} + jω {L}_{s} + jω {CR}_{0} ( {R}_{s} + jω {L}_{s} )} {V}_{D} \qquad Eq . 3$$

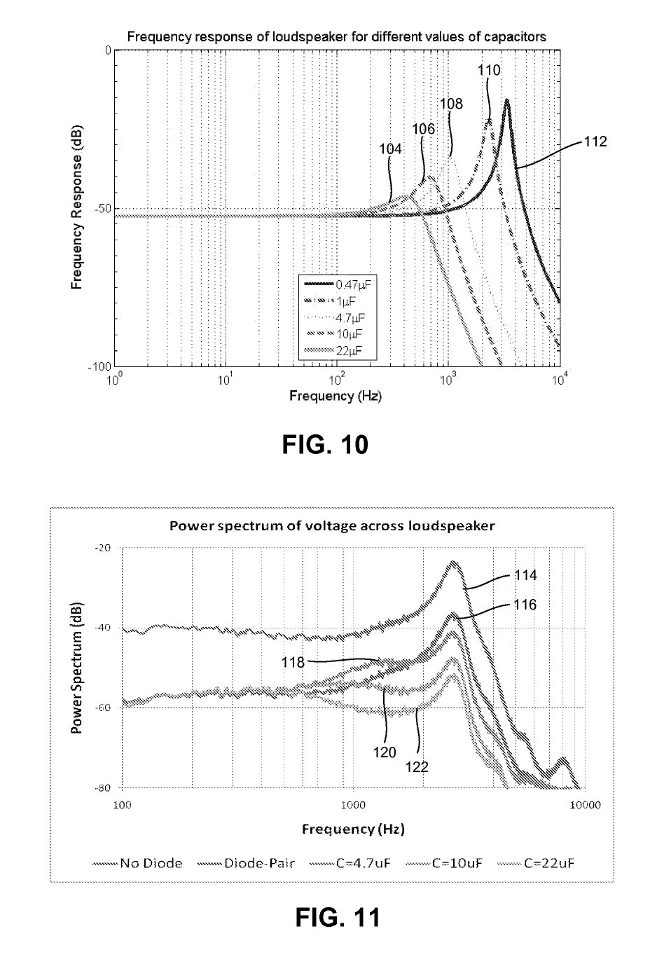

With additional reference to FIG. 10, illustrated is a graph of the calculated frequency response of the speaker 14 as calculated using equation 3 for different values of the capacitor 102. In the calculations, Rₒ was 4.7 kΩ, Rₛ was 11.1 kΩ, and Lₛ was 4.6 mH, which represents the characteristics for speaker model number BK26824. Curve 104 shows the results for a 22 μF capacitor, curve 106 shows the results for a 10 μF capacitor, curve 108 shows the results for a 4.7 μF capacitor, curve 110 shows the results for a 1 μF capacitor, and curve 112 shows the results for a 0.47 μF capacitor.

The results show that the larger the capacitance of the capacitor 102, the lower is the resonance frequency as indicated by the location of the peak of the various curves shown in FIG. 10. For example, if the capacitor 102 is a 10 μF capacitor, then the resonance frequency is about 700 Hz. At the passband, the frequency response is almost flat at low frequency (e.g., frequencies below about 200 Hz). At the stopband, the slope of the transition band is steep, which will be efficient in attenuating high frequency components. For example, if the capacitor 102 is a 4.7 μF capacitor, the slope is about 27 dB/octave.

With additional reference to FIG. 11, shown is a graph of the power spectrum of the voltage Vₛ across the speaker 14 when white noise is applied to the arrangement used for the experiment of section III(c)(ii) above (FIG. 5), except, for some of the curves, capacitor 102 is connected in parallel with the speaker 14. Curve 114 shows the results when no diode pair 48 is present (e.g., an open circuit in place of the diode pair 48) and no capacitor is connected in parallel with the speaker 14, curve 116 shows the results for when the diode pair 48 is present and no capacitor is connected in parallel with the speaker 14, curve 118 shows the results for when the diode pair 48 is present and a 4.7 μF capacitor is connected in parallel with the speaker 14, curve 120 shows the results for when the diode pair 48 is present and a 10 μF capacitor is connected in parallel with the speaker 14, and curve 122 shows the results for when the diode pair 48 is present and a 22 μF capacitor is connected in parallel with the speaker 14.

It is noted that the power spectrum of the voltage Vₛ will be affected by the characteristics of the test platform 56, including the characteristics of the microphones 22, 66, the speakers 14, 60, the amplifier 44′, the nonlinear circuit 32, and the soundcard in the computer 58. In the experiment leading to the results of FIG. 11, the speakers, resistor, and diodes of the test platform 56 were configured in the manner as described in connection with the section III(c)(ii), above.

The results show that the resonance frequency of the speaker 14 is between about 2 kHz to about 3 kHz. As shown in FIG. 10, the larger the value for capacitor 102, the lower the resonance frequency of the nonlinear circuit. Consequently, the power spectrum of voltage Vₛ in FIG. 11 has a larger attenuation at frequencies above about 1 kHz for larger values of the capacitor 102.

As a resulting design consideration, in one embodiment, the size of the capacitor may be about 10 μF. This size may provide a good tradeoff between sufficiently attenuating the high frequency components of the compressed gunshot impulse and introducing less distortion (muffle) to speech signals.

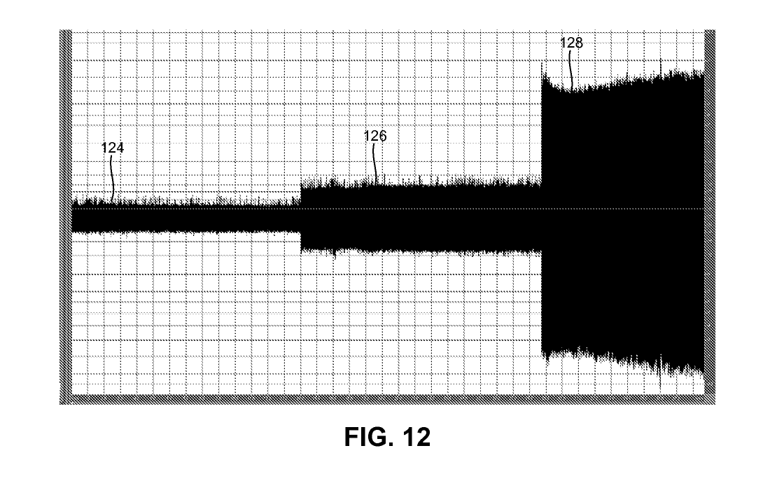

With additional reference to FIG. 12, the voltage signal Vₛ is shown in the time domain when the capacitor 102 is a 10 μF capacitor. A first segment 124 shows that an average level of voltage Vₛ is about −30 dB when both the capacitor 102 and the diode pair 48 are used as configured in FIG. 9. A second segment 126 shows that the average level of voltage Vₛ is about −21 dB when only the diode pair 48 is used. A third segment 128 shows that the average level of voltage Vₛ is about −8 dB when both the capacitor 102 and the diode pair 48 are not used. Therefore, the configuration with the diode pair 48 and the capacitor 102 achieves about 22 dB of attenuation on the loud white noise used to represent ambient sound.

### IV. Earmuff Embodiment

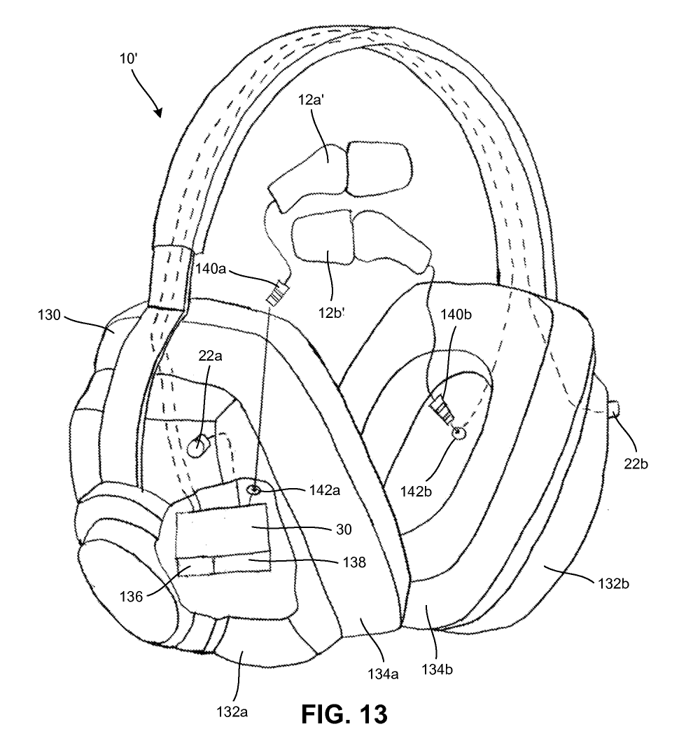

To increase isolation between ambient sounds and the ear of the user, earmuffs may be used in conjunction with the earpieces 12. With additional reference to FIG. 13, illustrated is another embodiment of the headset assembly 10′. The headset assembly 10′ includes a first earpiece 12a′ and a second earpiece 12b′. The first earpiece 12a′ may include the internal microphone 16 and the internal speaker 14a as is described above in connection with the earpiece 12a. Similarly, the second earpiece 12b′ may include the internal speaker 14b as is described above in connection with the earpiece 12b.

The headset assembly 10′ further includes a pair of earmuffs 130 that has a first cup 132a for covering one ear of the user and a second cup 132b for covering the other ear of the user. The cups 132 may include cushions 134a and 134b that generally conforms to the head of the user to increase sound isolation and comfort. In the embodiment of FIG. 13, the external microphones 22a and 22b are respectively mounted to the cups 132a and 132b.

In the illustrated embodiment, the electrical circuit 30 is built into one of the cups 132. A battery 136 may be present to power the electrical circuit 30. Also, a wireless transceiver 138 (e.g., a Bluetooth® transceiver) may be used to establish an interface with the electronic device 18 (not shown in FIG. 13). In alternative embodiments, the electrical circuit 30 may have a wired interface with the electronic device 18. Also, the headset assembly 10′ may be used independently of the electronic device 18 as a sound control device.

The earpieces 12 may be inserted into respective ears of the user and then plugs 140a and 140b may be connected to corresponding jacks 142a and 142b to connect the microphone 16 and speakers 14 to the electrical circuit 30. The jacks 142 may be located on the interior of the cups 132 and surrounded by the cushions 134 as shown in the illustrated embodiment. In this configuration, wires that connect the plugs 140 with the earpieces 12 may be located inside the cushion 134 when in use. Alternatively, the jacks 142 may be located on the exterior of the cups 132, in which case the wires may extend between the user and the cushion 134. Notches may be present in the cushion 134 to accommodate the wires. In other embodiments, the external microphone 22 and/or the earpieces 12 may be operatively connected to the electronic circuit 30 with wireless connections. In this case, the electronic circuit 30, the battery 136 and the wireless transceiver 138 need not be built into one of the cups 132.

The earmuffs 130 may provide a relatively high resistance against sound leakage between the earmuff cushions 134 and the user's head. For example, commercially available hearing protection earmuffs generally provide about 20 dB or more in NRR. As a specific example, Silencio model earmuffs available from Jackson Safety, Inc. of Fenton, Mo. have an NRR of 25 dB. Therefore, the use of the earmuffs 130 and the earpieces 12 together to provide sound insulation between the ear canal of the user and the user's environment may provide more than about 40 dB in NRR. This is close to the maximum noise isolation that is possible due to bone and tissue sound conduction pathways through the anatomy of the user. It is noted, however, that high frequency portions of ambient sound are attenuated by passive absorbers in the earmuffs 130, and the level of attenuation depends on the high frequency dynamic of the material of the cups 132 (or shell) and the cushions 134.

The passive isolation features of the earmuffs 130 and the earpieces 12 in combination with the active ambient sound control of the electrical circuit 30 should provide a high degree of sound protection to the user while still allowing the user to hear his or her surroundings.

### V. Conclusion

Although particular embodiments of the invention have been described in detail, it is understood that the invention is not limited correspondingly in scope, but includes all changes, modifications, and equivalents coming within the spirit and terms of the claims appended hereto.

What is claimed is:

1. An ambient sound control headset, comprising:
an external microphone that detects sounds from an environment of a user and outputs a corresponding signal;
an earpiece configured for at least partial insertion into an ear of a user and having an internal speaker driven by an input signal to emit sounds to an ear canal of the user, the emitted sounds representing the sounds from the environment; and
a circuit that is configured to amplify and act upon the signal output by the external microphone to form the signal input to the internal speaker in which components of the amplified signal output by the external microphone that have a corresponding volume level that are less than a predetermined threshold are allowed to pass to the internal speaker and components of the amplified signal output by the external microphone that have a corresponding volume level that are greater than the predetermined threshold are compressed to have a volume that is less than the predetermined threshold; and
wherein the circuit has a resistor in series with the internal speaker and a pair of diodes in parallel with the series resistor and speaker, the diodes arranged in parallel and having opposing bias directionalities; and
wherein the circuit applies a bias voltage to reduce a forward bias voltage threshold of at least one of the diodes.

2. The headset of claim 1, wherein the external microphone is retained by the earpiece.

3. The headset of claim 1, wherein the circuit includes an amplifier that amplifies the signal output by the microphone.

4. The headset of claim 3, wherein the amplifier includes a preamplifier and a power amplifier.

5. The headset of claim 1, wherein when a forward bias voltage of one of the diodes is exceeded by the amplified signal output by the external microphone, the diode conducts to clamp a voltage across the speaker.

6. The headset of claim 1, wherein a first capacitor is arranged in series with the resistor and internal speaker, and a second capacitor is arranged in series with the amplifier, the first and second capacitors configured to respectively block DC current to the internal speaker and the amplifier.

7. The headset of claim 1, wherein the electrical circuit is configured to filter high frequency components of the signal input to the internal speaker.

8. The headset of claim 7, wherein a capacitor is arranged in parallel with the internal speaker to filter the high frequency components.

9. The headset of claim 1, wherein the resistor is a variable resistor.

10. The headset of claim 1, further comprising:
a second external microphone that detects sounds from the environment of a user and outputs a corresponding signal;
a second earpiece configured for at least partial insertion into a second ear of a user and having a second internal speaker driven by an input signal to emit sounds to a second ear canal of the user, the emitted sounds representing the sounds from the environment; and
wherein the circuit is configured to amplify and act upon the signal output by the second external microphone to form the signal input to the second internal speaker in which components of the amplified signal output by the second external microphone that have a corresponding volume level that are less than the predetermined threshold are allowed to pass to the second internal speaker and components of the amplified signal output by the second external microphone that have a corresponding volume level that are greater than the predetermined threshold are compressed to have a volume that is less than the predetermined threshold.

11. The headset of claim 10, wherein the second external microphone is retained by the second earpiece.

12. The headset of claim 10, wherein the external microphones and internal speakers cooperate to provide stereophonic listening of the environment to the user.

13. The headset of claim 10, wherein the external microphones are retained by respective earmuffs, each surrounding a corresponding outer ear portion of the user and a corresponding earpiece.

14. The headset of claim 1, wherein the earpiece includes an internal microphone to detect sounds from the ear canal of the user and output a signal corresponding to the detected sounds.

15. The headset of claim 1, wherein the external microphone is retained by an earmuff that surrounds an outer ear of the user and the earpiece.

16. The headset of claim 15, wherein the earpiece has an electrical connector to connect to a mating electrical connector of the earmuff to establish electrical interface of components of the earpiece with components retained by the earmuff.
